(19) United States
(12) Patent Application Publication
(10) Pub. No.: US 2024/0234930 A9
(43) Pub. Date: Jul. 11, 2024

(54) BATTERY MODULE AND BATTERY PACK INCLUDING THE SAME

(71) Applicant: LG ENERGY SOLUTION, LTD., Seoul (KR)

(72) Inventors: Kwangmo KIM, Daejeon (KR); Hyemi JUNG, Daejeon (KR)

(73) Assignee: LG ENERGY SOLUTION, LTD., Seoul (KR)

(21) Appl. No.: 18/279,180

(22) PCT Filed: Mar. 3, 2022
(86) PCT No.: PCT/KR2022/002992

§ 371 Date: Aug. 28, 2023

(30) Foreign Application Priority Data
Mar. 16, 2021 (KR) 10-2021-0034064

(51) Int. Cl. H01M 50/333; H01M 50/211; H01M 50/325

(52) U.S. Cl. CPC H01M 50/333; H01M 50/211; H01M 50/325; H01M 2200/20

(57) ABSTRACT

A battery module includes a battery cell stack in which a plurality of battery cells are stacked; a module frame that houses the battery cell stack; and end plates arranged on both sides of the battery cell stack. At least one of the module frame and the end plate is formed with a venting part that discharges gas in one direction. The opening/closing of the venting part are adjusted according to the pressure rise inside the module frame.

### CROSS CITATION WITH RELATED APPLICATION(S)

This application claims the benefit of Korean Patent Application No. 10-2021-0034064 filed on Mar. 16, 2021 with the Korean Intellectual Property Office, the entire contents of which are incorporated herein by reference.

### TECHNICAL FIELD

The present disclosure relates to a battery module and a battery pack including the same, and more particularly to a battery module having enhanced safety and a battery pack including the same.

### BACKGROUND

In modern society, as portable devices such as a mobile phone, a notebook computer, a camcorder and a digital camera has been daily used, the development of technologies in the fields related to mobile devices as described above has been activated. In addition, chargeable/dischargeable secondary batteries are used as a power source for an electric vehicle (EV), a hybrid electric vehicle (HEV), a plug-in hybrid electric vehicle (P-HEV) and the like, in an attempt to solve air pollution and the like caused by existing gasoline vehicles using fossil fuel. Therefore, the demand for development of the secondary battery is growing.

Currently commercialized secondary batteries include a nickel cadmium battery, a nickel hydrogen battery, a nickel zinc battery, and a lithium secondary battery. Among them, the lithium secondary battery has come into the spotlight because they have advantages, for example, hardly exhibiting memory effects compared to nickel-based secondary batteries and thus being freely charged and discharged, and having very low self-discharge rate and high energy density.

Such lithium secondary battery mainly uses a lithium-based oxide and a carbonaceous material as a cathode active material and an anode active material, respectively. The lithium secondary battery includes an electrode assembly in which a cathode plate and an anode plate, each being coated with the cathode active material and the anode active material, are arranged with a separator being interposed between them, and a battery case which seals and houses the electrode assembly together with an electrolytic solution.

Generally, the lithium secondary battery may be classified based on the shape of the exterior material into a can-type secondary battery in which the electrode assembly is mounted in a metal can, and a pouch-type secondary battery in which the electrode assembly is mounted in a pouch of an aluminum laminate sheet.

In the case of a secondary battery used for small-sized devices, two to three battery cells are arranged, but in the case of a secondary battery used for a middle- or large-sized device such as an automobile, a battery module in which a large number of battery cells are electrically connected is used. In such a battery module, a large number of battery cells are connected to each other in series or parallel to form a cell assembly, thereby improving capacity and output. One or more battery modules can be mounted together with various control and protection systems such as a BDU (Battery Disconnect Unit), a BMS (battery management system) and a cooling system to form a battery pack.

FIG. 1 is a perspective view showing a conventional battery module.

Referring to FIG. 1, the conventional battery module 10 can be manufactured by housing a battery cell stack (not shown) in a module frame 20 and then joining an end plate 40 to an opened part of the module frame 20. At this time, the end plate 40 may be formed with a terminal busbar opening 41H where a part of the terminal busbar is exposed, and a module connector opening 42H where a part of the module connector is exposed. The terminal busbar opening 41H is for guiding the HV (high voltage) connection of the battery module 10, wherein the terminal busbar exposed through the terminal busbar opening 41H can be connected to another battery module or BDU (battery disconnect unit). The module connector opening 42H is for guiding the LV (Low voltage) connection of the battery module 10, wherein the module connector exposed through the module connector opening 42H can be connected to a BMS (battery management system) to transmit voltage information, temperature information, or the like of the battery cell.

FIG. 2 is a diagram showing a state when the battery module ignites in the conventional battery pack to which the battery module of FIG. 1 is mounted. FIG. 3 is a cross-sectional view taken along the cutting line I-I′ of FIG. 2, which is a cross-sectional view showing the state of flames that affect adjacent battery modules when the conventional battery module ignites.

Referring to FIGS. 1 to 3, the conventional battery module 10 includes a battery cell stack in which a plurality of battery cells 11 are stacked, a module frame 20 that houses the battery cell stack, and end plates 40 formed on the front and rear surfaces of the battery cell stack.

In the event of physical, thermal, or electrical damage to the battery cell, including overcharging, when the internal pressure of the battery cell 11 increases and exceeds a limit value of the fusion strength of the battery cell 11, high-temperature heat, gas, and flame generated in the battery cell 11 can be discharged to the outside of the battery cell 11.

At this time, high-temperature heat, gas and flame can be discharged through the openings 41H and 42H formed in the end plate 40. However, in a battery pack structure in which a plurality of battery modules 10 are arranged such that end plates 40 face each other, high-temperature heat, gas, flame, and the like ejected from the battery module 10 may affect adjacent battery modules 10. Thereby, the terminal busbar and the like formed on the end plate 40 of the adjacent battery modules can be damaged, and high-temperature heat, gas, and flame can enter the interior of the battery module 10 via the openings formed in the end plate 40 of the adjacent battery module 10 to damage other electrical components including the plurality of battery cells 11. In addition, this leads to heat propagation of the adjacent battery modules 10, which cause a chain ignition within the battery pack.

Therefore, there is a need to develop a technology capable of controlling high-temperature flames so that the influence on the adjacent battery modules can be minimized when thermal propagation occurs in the battery module.

### DETAILED DESCRIPTION OF THE INVENTION

### Technical Problem

It is an object of the present disclosure to provide a battery module that can quickly discharge a large amount of gas and at the same time, block the inflow of oxygen when an ignition phenomenon occurs within the battery module, and a battery pack including the same.

However, the problem to be solved by embodiments of the present disclosure is not limited to the above-described problems, and can be variously expanded within the scope of the technical idea included in the present disclosure.

### Technical Solution

According to an aspect of the present disclosure, there is provided a battery module comprising: a battery cell stack in which a plurality of battery cells are stacked; a module frame that houses the battery cell stack; and end plates arranged on opposite sides of the battery cell stack, wherein at least one of the module frame and the end plate is formed with a vent that discharges gas in one direction, and wherein the vent opens according to a rise in pressure inside the module frame.

The vent may include a through hole; a cover that closes the through hole; an outer shell located outside the cover and having an opened portion; and a spring located between the cover and the outer shell.

The outer shell may be a frame connected to the end plate or the module frame, and the spring may be fixed between the cover and the outer shell.

When gas is generated inside the battery module, the through hole blocked by the cover may be opened while the spring is compressed.

The vent may include a through hole; a cover that closes the through hole; and a hinge located on a first side of the cover that enables opening/closing of the cover, wherein when gas is generated inside the battery module, the cover moves outwardly.

The hinge may open the cover in the direction of an outside of the battery module.

A step may be formed in the through hole, and a second side of the cover is blocked by the step, so that the cover can only move outwardly.

The vent may further include an inside spring connected to the second side of the cover and the step.

An elastic force of the inside spring may act in a direction opposite to the direction in which the cover opens.

The vent may further include a protrusion formed on an inner wall of the through hole, and the protrusion may be located outside of the cover.

The battery module may further include an insulating cover located between the battery cell stack and the end plate. The vent may be formed in the end plate, and an insulating cover opening may be formed in the insulating cover at a position corresponding to the vent.

### Advantageous Effects

According to an embodiment of the present disclosure, when an ignition phenomenon occurs within the battery module, a venting part configured so as to discharge gas in one direction allows a large amount of gas to be discharged quickly, and at the same time block the inflow of oxygen.

Thereby, it is possible to eliminate the pressure rise inside the battery module and at the same time limit the supply of oxygen (air) in the explosion condition of a combustible gas, thereby suppressing the explosion and the development of flame of the battery module.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view showing a conventional battery module;

FIG. 2 is a diagram showing a state when the battery module ignites in the conventional battery pack to which the battery module of FIG. 1 is mounted;

FIG. 3 is a cross-sectional view taken along the cutting line I-I′ of FIG. 2;

FIG. 4 is a perspective view showing a battery module according to an embodiment of the present disclosure;

FIG. 5 is an exploded perspective view of the battery module of FIG. 4;

FIG. 6 is a perspective view showing a battery cell included in the battery module of FIG. 5;

FIG. 7 is a perspective view showing the second end plate of the battery module of FIG. 4 at different angles so as to be seen from the front;

FIG. 8 is a perspective view which shows an end plate and an insulating cover according to an embodiment of the present disclosure;

FIG. 9 is a cross-sectional perspective view showing a state cut along the cutting line A-A′ of FIG. 8;

FIG. 10 is a cross-sectional view of the end plate and the insulating cover of FIG. 9 as viewed in the −y-axis direction on the xz plane;

FIG. 11 is a cross-sectional view which shows a state in which gas is discharged when the internal pressure of the battery module rises against the end plate and the insulating cover of FIG. 10;

FIG. 12 is a perspective view showing a battery module according to another embodiment of the present disclosure;

FIG. 13 is a cross-sectional view showing a cross section taken along the cutting line B-B′ of FIG. 12;

FIG. 14 is a perspective view which shows an end plate and an insulating cover according to a modified embodiment of the present disclosure;

FIG. 15 is a cross-sectional view showing a state cut along the cutting line C-C′ of FIG. 14;

FIG. 16 is a cross-sectional view illustrating a state in which gas is discharged when the internal pressure of the battery module rises against the end plate and the insulating cover of FIG. 15; and

FIGS. 17 and 18 are cross-sectional views of end plates and insulating covers according to a modified embodiment of the present disclosure.

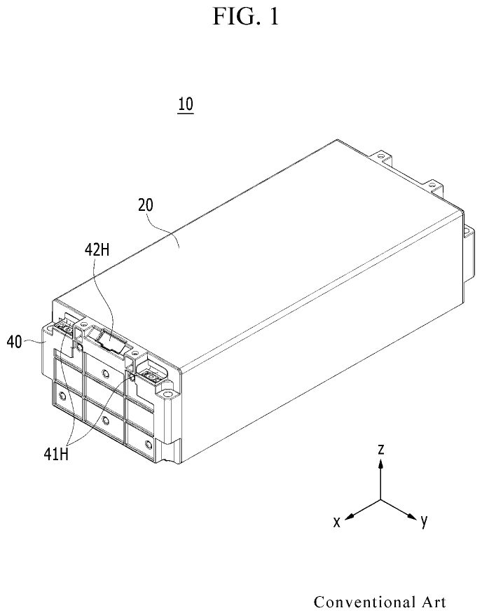

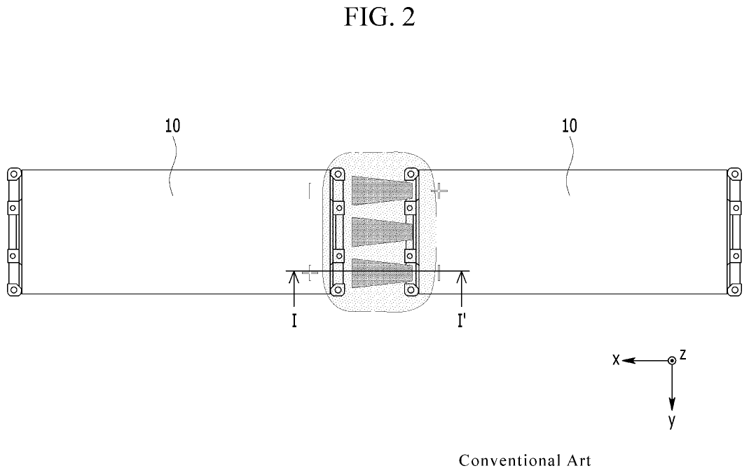

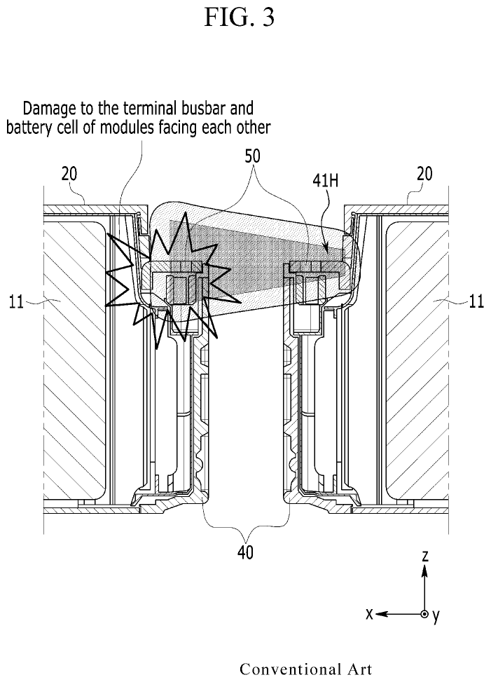

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed on the upper end of the reference portion toward the opposite direction of gravity.

Further, throughout the description, when a portion is referred to as “including” or “comprising” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

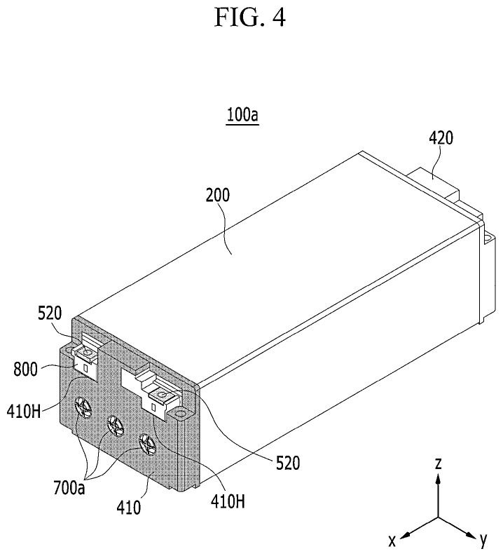

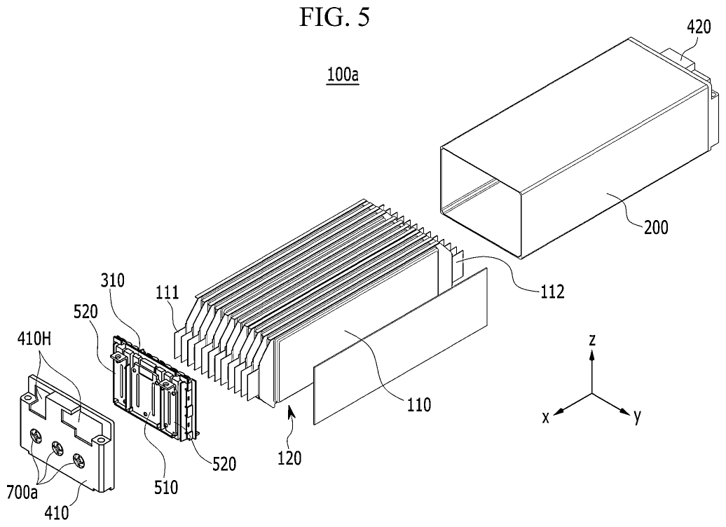

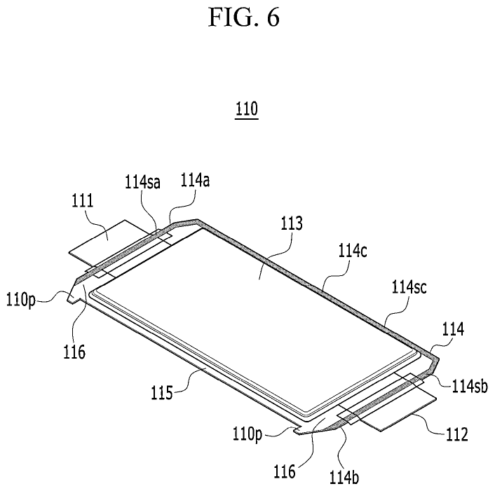

FIG. 4 is a perspective view showing a battery module according to an embodiment of the present disclosure. FIG. 5 is an exploded perspective view of the battery module of FIG. 4. FIG. 6 is a perspective view showing a battery cell included in the battery module of FIG. 5.

Referring to FIGS. 4 to 6, a battery module 100a according to one embodiment of the present disclosure includes a battery cell stack 120 in which a plurality of battery cells 110 are stacked; a module frame 200 that houses the battery cell stack 120; and end plates 410 and 420 arranged on both sides of the battery cell stack 120.

First, referring to FIG. 6, the battery cell 110 is preferably a pouch-type battery cell. For example, the battery cell 110 according to the present embodiment has a structure in which two electrode leads 111 and 112 face each other and protrude from one end 114a and the other end 114b of the cell main body 113, respectively. More specifically, the electrode leads 111 and 112 are connected to an electrode assembly (not shown), and protrude from the electrode assembly (not shown) to the outside of the battery cell 110.

Meanwhile, the battery cell 110 can be manufactured by joining both end parts 114a and 114b of the cell case 114 and one side part 114c connecting them, in a state in which the electrode assembly (not shown) is housed in a cell case 114. In other words, the battery cell 110 according to the present embodiment has a total of three sealing parts 114sa, 114sb and 114sc, the sealing parts 114sa, 114sb and 114sc have a structure sealed by a method such as heat fusion, and the remaining other side part may be formed of a connection part 115. The cell case 114 may be formed of a laminated sheet containing a resin layer and a metal layer.

In addition, the connection part 115 may extend long along one edge of the battery cell 110, and a protrusion part 110p of the battery cell 110 called a bat-ear may be formed at an end part of the connection part 115. Further, while the cell case 114 is sealed with the protruding electrode leads 111 and 112 being interposed therebetween, a terrace part 116 may be formed between the electrode leads 111 and 112 and the cell main body 113. That is, the battery cell 110 includes a terrace part 116 formed to extend from the cell case 114 in the direction in which the electrode leads 111 and 112 protrude.

The battery cell 110 may be composed by a plurality of numbers, and the plurality of battery cells 110 may be stacked so as to be electrically connected to each other, thereby forming a battery cell stack 120. Referring to FIG. 5, the battery cells 110 can be stacked along the y-axis direction to form a battery cell stack 120. A first busbar frame 310 may be located on one surface of the battery cell stack 120 in the direction (x-axis direction) in which the electrode leads 111 protrude. Although it is not specifically shown in the figure, a second busbar frame may be located on the other surface of the battery cell stack 120 in the direction (−x-axis direction) in which the electrode leads 112 protrude. The battery cell stack 120 and the first busbar frame 310 may be housed together with the module frame 200. The module frame 200 can protect the battery cell stack 120 housed inside the module frame 200 and the electrical components connected thereto from external physical impacts.

Meanwhile, the module frame 200 can be opened in the protruding direction of the electrode leads 111 and 112 (x-axis direction, −x-axis direction), and end plates 410 and 420 may be located on both open sides of the module frame 200, respectively. The two end plates 410 and 420 are referred to as a first end plate 410 and a second end plate 420, respectively. The first end plate 410 can be joined to the module frame 200 while covering the first busbar frame 310, and the second end plate 420 can be joined to the module frame 200 while covering the second busbar frame (not shown). That is, a first busbar frame 310 may be located between the first end plate 410 and the battery cell stack 120, and a second busbar frame (not shown) may be located between the second end plate 420 and the battery cell stack 120. Further, an insulating cover 800 (see FIG. 4) for electrical insulation may be located between the first end plate 410 and the first busbar frame 310.

The first end plate 410 and the second end plate 420 are located so as to cover the one surface and the other surface of the battery cell stack 120, respectively. The first end plate 410 and the second end plate 420 can protect the first busbar frame 310 and various electrical components connected thereto from external impacts. For this purpose, they must have a predetermined strength and may include a metal such as aluminum. Further, the first end plate 410 and the second end plate 420 may be joined to a corresponding edge of the module frame 200 by a method such as welding, respectively.

The first busbar frame 310 can be located on one surface of the battery cell stack 120 to cover the battery cell stack 120 and at the same time guide the connection between the battery cell stack 120 and external devices. Specifically, at least one of a busbar, a terminal busbar, and a module connector may be mounted onto the first busbar frame 310. Particularly, at least one of a busbar, a terminal busbar, and a module connector may be mounted onto a surface opposite to the surface of the first busbar frame 310 facing the battery cell stack. As an example, FIG. 5 shows a state in which the busbar 510 and the terminal busbar 520 are mounted onto the first busbar frame 310.

The electrode lead 111 of the battery cells 110 is bent after passing through a slit formed in the first busbar frame 310 and can be joined to the busbar 510 or the terminal busbar 520. The battery cells 110 constituting the battery cell stack 120 may be connected in series or in parallel by the busbar 510 or the terminal busbar 520. Further, the battery cells 110a can be electrically connected to an external device or circuit through the terminal busbar 520 exposed to the outside of the battery module 100.

The first busbar frame 310 may include an electrically insulating material. The first busbar frame 310 restricts the busbar 510 or the terminal busbar 520 from making contact with the battery cells 110, except for the portion where the busbar 510 or the terminal busbar 520 is joined to the electrode leads 111, thereby preventing the occurrence of a short circuit.

Meanwhile, as described above, the second busbar frame may be located on the other surface of the battery cell stack 120, and at least one of the busbar, the terminal busbar, and the module connector may be mounted onto the second busbar frame. An electrode lead 112 can be joined to such a busbar.

An opening in which at least one of the terminal busbar and the module connector is exposed can be formed in the first end plate 410 according to the present embodiment. The opening may be a terminal busbar opening or a module connector opening. In one example, as shown in FIGS. 4 and 5, a terminal busbar opening 410H where the terminal busbar 520 is exposed can be formed in the first end plate 410. The terminal busbar 520 further includes an upwardly protruding portion as compared with the busbar 510. Such upwardly protruding portion may be exposed to the outside of the battery module 100a via the terminal busbar opening 410H. The terminal busbar 520 exposed via the terminal busbar opening 410H may be connected to another battery module or BDU (battery disconnect unit) to form a high voltage (HV) connection.

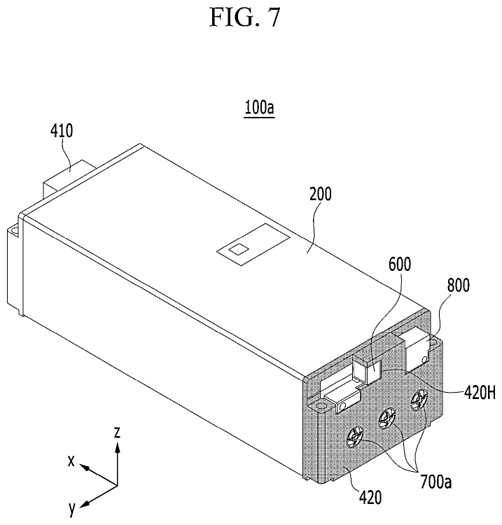

FIG. 7 is a perspective view showing the second end plate of the battery module of FIG. 4 at different angles so as to be seen from the front.

Referring to FIG. 7, as an example, a module connector opening 420H through which the module connector 600 is exposed may be formed in the second end plate 420. This means that the module connector 600 is mounted on the above-mentioned second busbar frame. The module connector 600 can be connected to a temperature sensor, a voltage measuring member, or the like provided inside the battery module 100a. Such a module connector 600 is connected to an external BMS (battery management system) to form an LV (Low voltage) connection, and it performs a function of transmitting temperature information, voltage level and the like measured by the temperature sensor or the voltage measuring member to the external BMS.

The first end plate 410 and the second end plate 420 shown in FIGS. 4, 5 and 7 are exemplary structures. According to another embodiment of the present disclosure, a module connector is mounted onto the first busbar frame 310 and a terminal busbar may be mounted onto the second busbar frame. Thereby, a module connector opening may be formed in the first end plate, and a terminal busbar opening may be formed in the second end plate.

Meanwhile, the end plates 410 and 420 according to the present embodiment cover the front and rear surfaces of the battery cell stack 120, and the module frame 200 covers the upper surface, the lower surface, and both side surfaces of the battery cell stack 120. Here, the front surface means a surface of the battery cell stack 120 in the x-axis direction, and the rear surface means a surface of the battery cell stack 120 in the −x-axis direction. The upper surface means a surface of the battery cell stack 120 in the −z-axis direction, the lower surface means a surface of the battery cell stack 120 in the −z-axis direction, and both side surfaces mean surfaces of the battery cell stack 120 in the y-axis and −y-axis directions, respectively. However, these are surfaces mentioned for convenience of explanation, and may vary depending on the position of a target object or the position of an observer. As described above, the front surface and the rear surface of the battery cell stack 120 may be surfaces on which the protruded electrode leads 111 and 112 of the battery cells 110 are located.

According to the present embodiment, at least one of the module frame 200 and the end plates 410 and 420 may include a venting part 700a that discharges gas in one direction.

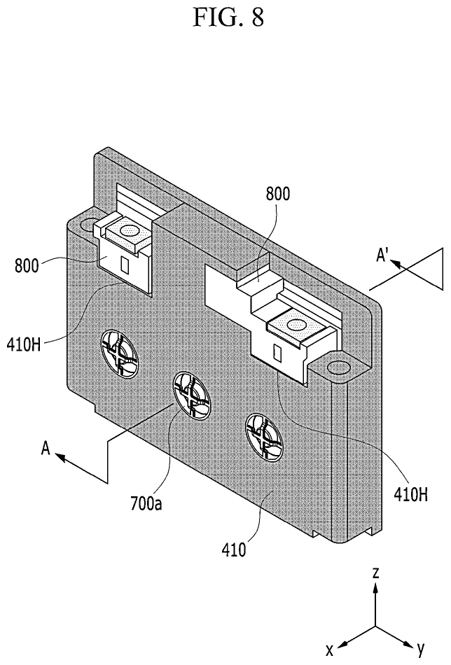

Next, in accordance with an embodiment of the present disclosure, the venting part formed on the first end plate will be described in detail with reference to FIGS. 8 to 10. In order to avoid repetition of the description, the first end plate 410 will be mainly described, but the same or similar structures can be applied even to the second end plate 420.

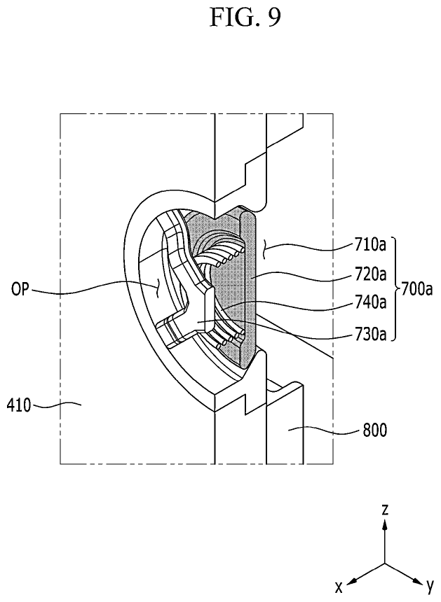

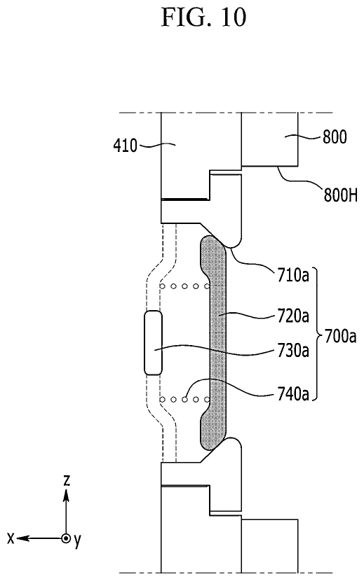

FIG. 8 is a perspective view which shows an end plate and an insulating cover according to an embodiment of the present disclosure. FIG. 9 is a cross-sectional perspective view showing a state cut along the cutting line A-A′ of FIG. 8. FIG. 10 is a cross-sectional view of the end plate and the insulating cover of FIG. 9 as viewed in the −y-axis direction on the xz plane.

Referring to FIGS. 8 to 10, the venting part 700a according to the present embodiment adjusts its opening/closing in accordance with the pressure rise inside the module frame 200, and when the pressure inside the module frame 200 rises, gas is discharged in one direction.

Specifically, the venting part 700a may include a through hole 710a, a cover part 720a that closes the through hole 710a, an outer shell part 730a located outside the cover part 720a and having an opened portion OP formed thereon, and a spring part 740a located between the cover part 720a and the outer shell part 730a.

The through hole 710a may be a portion that is formed on one surface of the first end plate 410 and pierced so as to penetrate the first end plate 410. The shape of the through hole 710a is not particularly limited, and all of a circular shape, a polygonal shape, an oval shape, and the like are available. A circular through hole 710a is shown as an example in FIG. 9.

The cover part 720a may be arranged so as to close the whole of the pierced portion of the through hole 710a from the outside. In a normal operating state, the cover part 720a closes the through hole 710a to maintain the battery module 100a in a tightly sealed manner, thereby capable of preventing foreign mattes from inflowing from the outside during the assembly process, transport process, normal operation process, and the like.

The outer shell part 730a may be in the form of a frame connected to the first end plate 410. For example, as shown in FIG. 9, the outer shell part 730a may have a shape in which a cross-shaped frame is arranged on one surface of the first end plate 410. Because the outer shell is in the form of a frame, an open portion OP is naturally formed between the frames. The outer shell part 730a may be located outside the cover part 720a and cover the cover port 720a, but it is not sealed by the outer shell part 730a because the open portion OP is provided between the frames.

Although not shown in detail in the figure, the outer shell part 730a may be in the form of a straight shaped frame. Moreover, even if the outer shell part is not in the form of a frame, it is not particularly limited in structure, as long as if it is located outside the cover part 720a to form an open portion, and a spring part 740a described later can be fixed therebetween.

The spring part 740a is an elastic member located between the cover part 720a and the outer shell part 730a, and is preferably arranged so that an elastic force acts in the same direction as the opening direction of the through hole 710a. Here, the opening direction of the through hole 710a means a direction parallel to the x-axis. In one example, the spring part 740a, which is a coil-shaped spring, may be arranged in parallel with the opening direction of the through hole 710a. The spring part 740a may be fixed between the cover part 720a and the outer shell part 730a. For fixing, the spring part 740a may be located between the cover part 720a and the outer shell part 730a in a slightly compressed state. Due to the elastic force of the spring part 740a, it is possible to maintain the state in which the cover part 720a normally block the through hole 710a.

Meanwhile, the outer shell part 730a may be in the form of a frame as described above, but in order to stably mount the spring part 740a, a portion in contact with the spring part 740a may be bent so as to protrude outward. The spring part 740a is mounted in compliance with the bent portion, so that the spring part 740a can be more stably fixed between the cover part 720a and the outer shell part 730a.

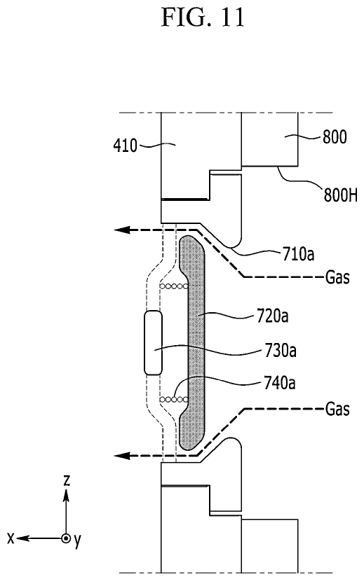

FIG. 11 is a cross-sectional view which shows a state in which gas is discharged when the internal pressure of the battery module rises against the end plate and the insulating cover of FIG. 10.

Referring to FIG. 11 together with FIGS. 9 and 10, when the battery module 100a is placed in an abnormal operating state, and high-temperature heat, gas, flame, and the like are generated, the increased internal pressure can push out the cover part 720a and compress the spring part 740a. That is, when gas is generated inside the battery module 100a, the through hole 710a closed by the cover part 720a may be opened while the spring part 740a is compressed. Thereby, a large amount of gas can be quickly discharged through the through hole 710a and the open portion OP of the outer shell part 730a. It is possible to limit a sudden rise in the pressure inside the battery module 100a.

After the gas is discharged to some extent, the through hole 710a is again closed by the cover part 720a due to the elastic force of the spring part 740a. Only gas is discharged, and external oxygen (air) can be blocked from flowing into the interior. Since the pressure inside the battery module 100a is in a very high state while the through hole 710a is open, it is difficult for external oxygen (air) to inflow. That is, the venting part 700a according to the present embodiment can quickly discharge a large amount of gas and at the same time block the inflow of oxygen. This eliminates the pressure rise inside the battery module and at the same time limits the supply of oxygen (air) during explosion conditions of a combustible gas, whereby even if the battery module 100a is placed in an abnormal operating state, it is possible to prevent the explosions and the development of a flame.

Further, in the case of the venting part 700a according to the present embodiment, it is configured such that the cover part 720a closing the through hole 710a directly receives the pressure of the internal gas of the battery module 100a, and the spring part 740a for adjusting the opening/closing of the through hole 710a and the cover part 720a is located outside the cover part 720a. In the present embodiment, the area of the cover part 720a on which the internal pressure acts may be set to be larger than when the spring part 740a is located inside the cover part 720a. That is, since the area on which the internal pressure acts can be provided large, the venting part 700a according to the present embodiment is advantageous in that it can respond more sensitively to the change of the internal pressure of the battery module 100a to smoothly perform the opening/closing operation. When the spring part 740a is located inside the battery module, the area receiving the pressure of the internal gas of the battery module 100a is reduced, so that the opening/closing operation may not be performed properly.

Meanwhile, the number of such venting part 700a is not particularly limited, and it may be arranged in a single number or a plurality of numbers. As an example, it is shown in FIG. 8 that three venting parts 700a are provided.

Meanwhile, as described above, an insulating cover 800 for electrical insulation may be located between the first end plate 410 and the first busbar frame 310 (see FIG. 5). Any electrically insulating material can be applied as the insulating cover 800 without limitation. At this time, as shown in FIGS. 10 and 11, an insulating cover opening 800H may be formed at a position corresponding to the venting part 700a of the insulating cover 800. Gas inside the battery module may sequentially pass through the insulating cover opening 800H and the venting part 700a to be discharged to the outside.

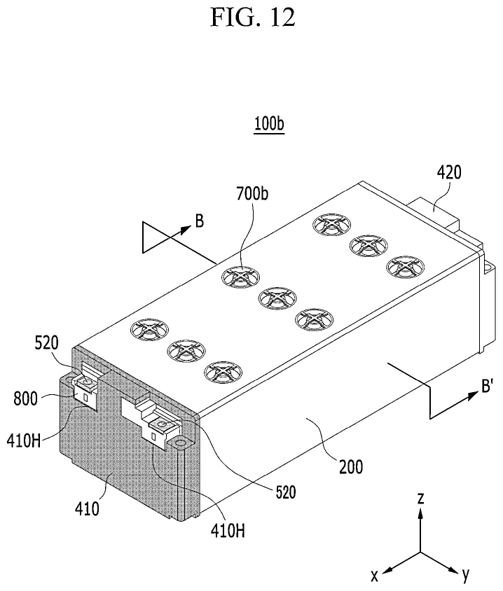

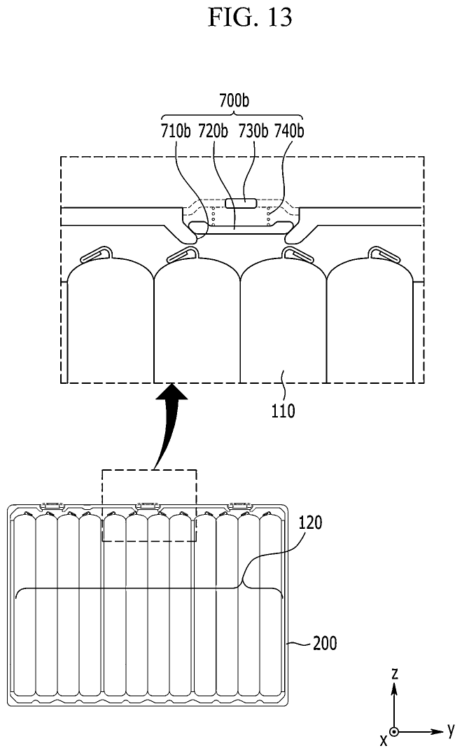

Next, in accordance with another embodiment of the present invention, a venting part formed in a module frame will be described in detail with reference to FIGS. 12 and 13.

FIG. 12 is a perspective view showing a battery module according to another embodiment of the present disclosure. FIG. 13 is a cross-sectional view showing a cross section taken along the cutting line B-B′ of FIG. 12.

Referring to FIGS. 12 and 13, the battery module 100b according to another embodiment of the present disclosure includes a module frame 200 that houses the battery cell stack 120, and a venting part 700b formed in the module frame 200.

Specifically, the venting part 700b may include a through hole 710b, a cover part 720b that closes the through hole 710b, an outer shell part 730b located outside the cover part 720b and having an opened portion formed thereon, and a spring part 740b located between the cover part 720b and the outer shell part 730b.

The through hole 710b may be a portion that is formed on one surface of the module frame 200 and pierced so as to penetrate through the module frame 200. The cover part 720b may be arranged so as to close the whole of the pierced portion of the through hole 710b from the outside. The outer shell part 730b may be in the form of a frame connected to the module frame 200. For example, as shown in FIG. 12, the outer shell part 730b may have a shape in which a cross-shaped frame is arranged on one surface of the module frame 200. Because the outer shell part is in the form of a frame, an open portion is naturally formed between the frames. The spring part 740b is an elastic member located between the cover part 720b and the outer shell part 730b, and may be arranged so that an elastic force act in the same direction as the opening direction of the through hole 710b.

That is, the venting part 700b according to the present embodiment has a structure similar to that of the venting part 700a formed on the end plates 410 and 420. The venting part 700b may have a structure in which opening/closing is adjusted in accordance with the pressure rise inside the module frame 200, and gas is discharged in one direction when the pressure inside the module frame 200 rises.

Although the venting part 700b is shown to be formed on the upper surface of the module frame 200, the position thereof is not particularly limited, and it can also be formed on the lower surface or both side surfaces. However, in the case of the lower surface, gas discharge may be restricted.

Meanwhile, since the module frame 200 may have a relatively large area compared to the end plates 410 and 420, the number of venting parts 700b may be increased compared to the case where they are formed in the end plates 410 and 420. Also, the opening area of the through hole 710b may be increased. The increased number of venting parts 700b or the opening area of the through holes 710b is more effective in dispersing gas and flame.

Further, since the venting part 700b is formed on one surface of the module frame 200, it is possible to reduce the amount of gas or flame itself that is discharged in the direction in which the end plate is located.

In particular, as shown in the figure, the venting parts 700b may be formed on the upper surface of the module frame 200. In this case, the discharge of gas or flame may be induced so as to occur at the upper part of the battery module 100b. Therefore, it is possible to reduce damage to other battery modules mainly arranged on the side.

Meanwhile, the venting part 700a formed in the end plates 410 and 420 and the venting part 700b formed in the module frame 200 have been separately described, but a battery module according to another embodiment of the present disclosure may include both the venting parts 700a formed on end plates 410 and 420 and the venting part 700b formed in the module frame 200.

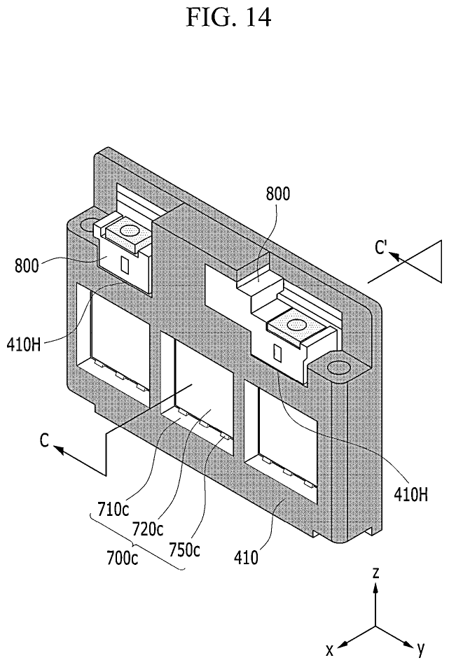

Next, the venting part according to a modified embodiment of the present disclosure will be described in detail with reference to FIGS. 14 to 16. In order to avoid repetition of the description, the first end plate 410 will be mainly described, but the same or similar structures can be applied even to the second end plate 420.

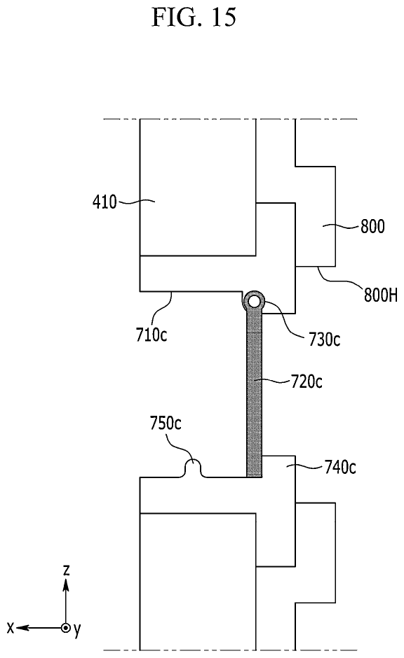

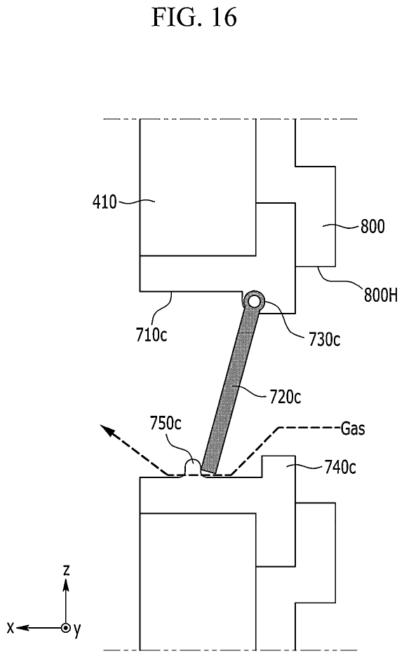

FIG. 14 is a perspective view which shows an end plate and an insulating cover according to a modified embodiment of the present disclosure. FIG. 15 is a cross-sectional view showing a state cut along the cutting line C-C′ of FIG. 14. FIG. 16 is a cross-sectional view illustrating a state in which gas is discharged when the internal pressure of the battery module rises against the end plate and the insulating cover of FIG. 15.

Referring FIGS. 14 to 16, the venting part 700c according to a modified embodiment of the present disclosure may include a through hole 710c, a cover part 720c that closes the through hole 710c and a hinge part 730c that is located on one side of the cover part 720c and enables opening/closing of the cover part 720c.

The through hole 710c may be a portion that is formed on one surface of the first end plate 410 and pierced so as to penetrate the first end plate 410. The shape of the through hole 710c is not particularly limited, and all of a circular shape, a polygonal shape, an oval shape, and the like are available. However, considering the configuration of the hinge part 730c, a square through hole 710c as shown may be preferred.

The cover part 720c may be arranged so as to close the whole of the pierced portion of the through hole 710c. In a normal operating state, the cover part 720c closes the through hole 710c to keep the battery module in a tightly sealed manner, thereby capable of preventing foreign mattes from inflowing from the outside during the assembly process, transport process, normal operation process, and the like.

The hinge part 730c is a structure located on one side of the cover part 720c, and enables opening/closing of the cover part 720c. In particular, when gas is generated inside the battery module, the cover part 720c may be opened in the direction of the outside of the battery module. The hinge part 730c may open the cover part 720c in the direction of the outside of the battery module.

Specifically, a step part 740c may be formed in the through hole 710c according to the present embodiment. The step part 740c may be located inside the cover part 720c. The other side of the cover part 720c facing one side of the cover part 720c provided with the hinge part 730c is blocked by the step part 740c, so that the cover part 720c can be opened only in the direction of the outside of the battery module as shown in FIG. 16.

Meanwhile, the venting part 700c according to the present embodiment may include a protrusion part 750c formed on the inner wall of the through hole 710c. This protrusion part 750c may be located outside the cover part 720c. More specifically, when the cover part 720c is opened, the protrusion part 750c may be located such that the other side of the cover part 720c opposite to the one side of the cover part 720c can contact the protrusion part 750c.

As shown in FIG. 14, the protrusion parts 750c may be formed by a plurality of numbers, and each thereof may be arranged while being spaced apart along a direction parallel to one surface of the cover part 720c. A space may be provided between the respective protrusion parts 750c.

As shown in FIG. 16, when the battery module is placed in an abnormal operating state and high-temperature heat, gas and flame are generated, the increased internal pressure can push out the cover part 720c to open the through hole 710c. Thereby, a large amount of gas can be quickly discharged through the through hole 710c. It is possible to limit the sudden rise of the pressure inside the battery module.

When the gas is discharged to some extent, the pressure inside the battery module decreases, and the through hole 710c is clogged again while the cover part 720c is closed. Only gas is discharged, and external oxygen (air) can be blocked from flowing into the interior. In particular, as the protrusion part 750c is provided, the rotation range of the cover part 720c is limited, and the through hole 710c may be opened only to the extent that gas is discharged. Because the cover part 720c is opened only at a small interval, the cover part 720c is closed again when the pressure inside the battery module is reduced. In addition, while the through hole 710c is open, the pressure inside the battery module is in a very high state, which thus makes it difficult for external oxygen (air) to inflow. That is, the venting part 700c according to the present embodiment can quickly discharge a large amount of gas and at the same time block the inflow of oxygen. This eliminates the pressure rise inside the battery module and at the same time limits the supply of oxygen (air) during explosion conditions of a combustible gas, whereby even if the battery module is placed in an abnormal operating state, it is possible to prevent the explosion and the development of a flame.

Meanwhile, the number of such venting parts 700c is not particularly limited, and may be arranged in a single number or a plurality of numbers. As an example, it is shown in FIG. 14 that three venting parts 700c are provided.

Next, as a modified embodiment of the present disclosure, a venting part including an inside spring part will be described in detail.

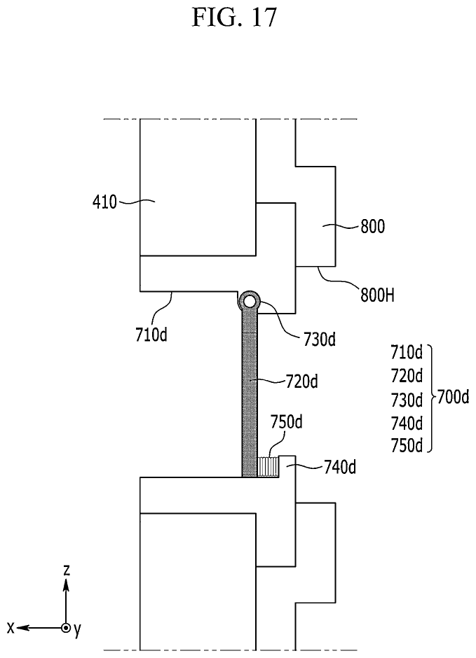

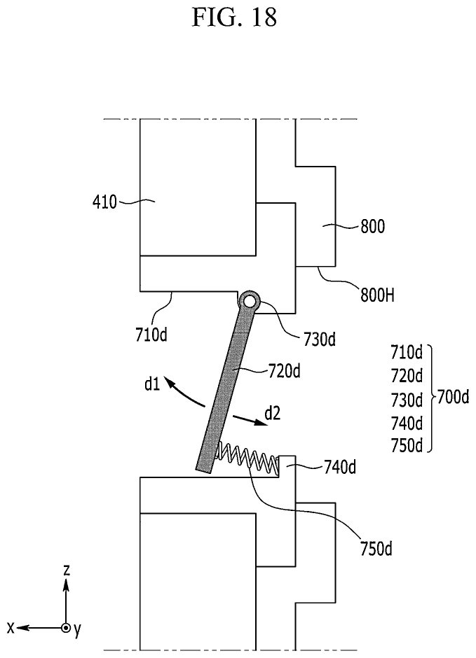

FIGS. 17 and 18 are cross-sectional views of end plates and insulating covers according to a modified embodiment of the present disclosure. Specifically, FIG. 17 shows a state before the internal pressure rises, and FIG. 18 shows a state after the internal pressure rises.

Referring to FIGS. 17 and 18, the venting part 700d according to a modified embodiment of the present disclosure may be formed in the end plate 410. The venting part 700d according to the present embodiment may include a through hole 710d, a cover part 720d that closes the through hole 710d and a hinge part 730d located on one side of the cover part 720d and enables opening/closing of the cover part 720d. Further, a step part 740d located inside the cover part 720d may be formed in the through hole 710d. Further, the insulating cover opening 800H may be formed at a position corresponding to the venting part 700d of the insulating cover 800. Each configuration described above overlaps with the contents described for the venting part 700c, and thus, a detailed description thereof is omitted.

The venting part 700d according to the present embodiment may further include an inside spring part 750d connected to the other side of the cover part 720d and each of the step parts 740d. The other side of the cover part 720d may be a portion facing the one side of the cover part 720d on which the hinge part 730d is located.

The other side of the cover portion 720d is blocked by the step part 740d, so that the cover part 720d can be opened only in the direction of the outside of the battery module. At this time, as the inside spring part 750d is arranged, the elastic force of the inside spring part 750d acts in a direction d2 opposite to the direction d1 in which the cover part 720d opens.

Normally, as shown in FIG. 17, the cover part 720d is kept in a closed state by the elastic force of the inside spring part 750d. However, when the battery module is placed in an abnormal operating state and high-temperature heat, gas, and flame are generated, the internal pressure increases beyond the elastic force of the inside spring part 750d to push out the cover part 720d as shown in FIG. 18. Thereby, the through hole 710d is opened, and a large amount of gas can be quickly discharged through the through hole 710d. Of course, when the degree of the increase in the internal pressure of the battery module is large, the cover part 720d may be opened larger than that shown in FIG. 18.

When the gas is discharged and the internal pressure is reduced, the cover part 720d is maintained in a closed state again by the elastic force of the inside spring part 750d. Only gas is discharged, and external oxygen (air) can be blocked from flowing into the interior. While the through hole 710d is opened, the pressure inside the battery module is in a very high state, which thus makes it difficult for external oxygen (air) to inflow. That is, the venting part 700d according to the present embodiment can quickly discharge a large amount of gas and at the same time block the inflow of oxygen. Thereby, it eliminates the pressure rise inside the battery module and at the same time limits the supply of oxygen (air) during the explosion condition of a combustible gas, whereby even if the battery module is placed in an abnormal operating state, it is possible to prevent the explosion or the development of a flame.

According to the present embodiment, the venting part 700d having the inside spring part 750d may have a structure in which opening/closing is adjusted in accordance with the pressure rise inside the battery module, and the gas is discharged in one direction when the pressure inside the battery module rises.

The terms representing directions such as the front side, the rear side, the left side, the right side, the upper side, and the lower side have been used in embodiments of the present disclosure, but the terms used are provided simply for convenience of description and may become different according to the position of an object, the position of an observer, or the like.

The one or more battery modules according to embodiments of the present disclosure described above can be mounted together with various control and protection systems such as a BMS (battery management system), a BDU (battery disconnect unit), and a cooling system to form a battery pack.

The battery module or the battery pack can be applied to various devices. For example, it can be applied to vehicle means such as an electric bike, an electric vehicle, and a hybrid electric vehicle, and may be applied to various devices capable of using a secondary battery, without being limited thereto.

The present disclosure has been described in detail with reference to exemplary embodiments thereof, but the scope of the present disclosure is not limited thereto and modifications and improvements made by those skilled in the part by using the basic concept of the present disclosure, which are defined in the following claims, also belong to the scope of the present disclosure.

### DESCRIPTION OF REFERENCE NUMERALS

100a, 100b: battery module
200: module frame
410: first end plate
700a, 700b, 700c, 700d: venting part

1. A battery module comprising:
a battery cell stack in which a plurality of battery cells are stacked; a module frame that houses the battery cell stack; and
end plates arranged on opposite sides of the battery cell stack,
wherein at least one of the module frame and the end plate is formed with a vent that discharges gas in one direction, and
wherein the vent opens according to a rise in pressure inside the module frame.

2. The battery module according to claim 1, wherein the vent comprises:
a through hole;
a cover that closes the through hole;
an outer shell located outside the cover and having an opened portion; and
a spring located between the cover and the outer shell.

3. The battery module according to claim 2, wherein the outer shell is a frame connected to the end plate or the module frame, and
wherein the spring is fixed between the cover and the outer shell.

4. The battery module according to claim 2, wherein,
when gas is generated inside the battery module, the through hole blocked by the cover is opened while the spring is compressed.

5. The battery module according to claim 1, wherein the vent comprises:
a through hole;
a cover that closes the through hole; and
a hinge located on a first side of the cover that enables opening/closing of the cover, and
wherein when gas is generated inside the battery module, the cover moves outwardly.

6. The battery module according to claim 5, wherein the hinge opens the cover in the direction of an outside of the battery module.

7. The battery module according to claim 5, wherein a step is formed in the through hole, and
wherein a second side of the cover is blocked by the step, so that the cover can only move outwardly.

8. The battery module according to claim 7, wherein the vent further comprises an inside spring connected to the second side of the cover and the step.

9. The battery module according to claim 8, wherein an elastic force of the inside spring acts in a direction opposite to a direction in which the cover opens.

10. The battery module according to claim 5, wherein the vent further comprises a protrusion formed on an inner wall of the through hole, and
wherein the protrusion is located outside of the cover.

11. The battery module according to claim 1, further comprising:
an insulating cover located between the battery cell stack and the end plate,
wherein the vent is formed in the end plate, and
wherein an insulating cover opening is formed in the insulating cover at a position corresponding to the vent.

12. A battery pack comprising the battery module according to claim 1.
